(19) United States
(12) Patent Application Publication
(10) Pub. No.: US 2006/0201444 A1
(43) Pub. Date: Sep. 14, 2006

(54) Horse arena composition and method

(76) Inventors: Donna J. Coss, Freeport, IL (US); David D. Brooks, Woodstock, IL (US)

Correspondence Address: WILDMAN HARROLD ALLEN & DIXON, 225 WEST WACKER DRIVE, SUITE 2800, CHICAGO, IL, 60606, US

(21) Appl. No.: 11/077,815

(22) Filed: Mar. 11, 2005

(51) Int. Cl. A01K 15/02

(52) U.S. Cl. 119/703

(57) ABSTRACT

A horse arena comprises an additive incorporated into its footing. The additive may be employed in indoor or outdoor horse arenas. In one embodiment, the additive may include an internal porosity in which at least some of the pores are interconnected via an open network of pore spaces. In other embodiments, the additive is capable of maintaining its internal porosity after undergoing thermal modification via superheating. In addition, the additive of the present invention may display a large surface area.

### FIELD OF THE INVENTION

The present invention relates to horse arenas and more particularly to compositions useful in the footings of horse arenas.

### BACKGROUND OF THE INVENTION

Horse arenas include a riding surface, often called the footing. Sand is the most common ingredient in footings, and sand alone may be used when a good solid base is provided to support horse traffic. Additional materials may, and often are, incorporated into the footing.

### SUMMARY OF THE INVENTION

The present invention concerns an additive designed to improve the footing.

In one embodiment, the method of the present invention comprises providing a horse arena including a footing, the footing comprising sand and an organic material, providing an additive comprising a plurality of particles, wherein at least one particle in the plurality of particles exhibits a surface area between about 10 meters squared per gram and 1000 meters squared per gram and applying the additive to the footing in an amount between about 0.5 lbs/ft² and about 7.5 lbs/ft².

In a second embodiment, the method of the present invention comprises providing a horse arena including a footing, providing an additive comprising a plurality of pores, wherein at least one of the plurality of pores has a pore size of about 0.0001 to about 10 microns in diameter and at least some of the plurality of pores interconnect and applying the additive to the footing.

In a third embodiment, the method of the present invention comprises providing a horse arena including a footing, providing an additive comprising a plurality of superheated particles comprising a plurality of pores, wherein at least one of the plurality of pores does not collapse after superheating and wherein at least some of the plurality of pores are interconnected and applying the additive to the footing.

In a fourth embodiment, the method of the present invention comprises providing a horse arena including a footing, providing an additive selected from the group consisting of a phyllosilicate clay mineral, diatomaceous earth and a zeolite and applying the additive to the footing, wherein the footing, prior to the step of applying the additive, includes a dry dust index and the applying step reduces the dry dust index by about 10% to about 50%.

In a fifth embodiment, the method of the present invention comprises providing a horse arena including a footing, the footing comprising a material selected from the group consisting of a phyllosilicate clay mineral, diatomaceous earth and a zeolite, wherein the material is present in the footing in an amount between about 1 pound per square foot to 6 pounds per square foot and wherein the footing includes an impact value of between about 7.0 cmax and 15.0 cmax.

### DETAILED DESCRIPTION

The additive of the present invention is incorporated into the footings of horse arenas. As used herein, the term horse arena means an area on which competitions or practice sessions involving horses take place, such as show or rodeo arenas and race tracks. The term footing means the riding surface of a horse arena. The additive of the present invention may be employed in indoor or outdoor horse arenas.

The additive may comprise phyllosilicate clay minerals, diatomaceous earth or zeolites. As described more fully hereinafter, these materials share characteristics beneficial to the footing of a horse arena.

According to one embodiment of the present invention, the additive may comprise a phyllosilicate clay mineral. Phyllosilicates include the smectite and hormite families. The crystal habits of these families of clay are often flat, platy, book-like or acicular and most members display good basal cleavage. Although members tend to be soft, they can be remarkably resilient. In addition, phyllosilicates are often the last to chemically break down in erosional and weathering processes, and thus constitute a significant amount of fine grained sedimentary rocks. This group may also be generally tolerant of high pressures and temperatures.

The smectite family of clay minerals includes, but is not limited to the montmorillonite, beidellite, nontronite, hectorite, vermiculite, illite and saponite species of clays, one or more of which may be present in varying amounts. Typically, smectite minerals occur as extremely small particles.

The hormite family of clay minerals includes, but is not limited to the attapulgite, often called palygorskite, and sepiolite species of clays. Some hormite minerals can form large crystals, and are often found in lucustrian or marine sediment or sometimes in hydrothermal deposits and/or soils.

Certain other embodiments of the present invention, neither of the smectite genus nor of the hormite variety, that may be employed include diatomaceous earth and zeolites. Diatomaceous earth is a geological deposit that may be made up of the fossilized skeletons and tests of siliceous marine and fresh water or other organisms, particularly diatoms and other algae. These skeletons may comprise hydrated amorphous silica or opal. Zeolites are porous crystalline solids that may contain silicon, aluminum or oxygen in their framework. Many zeolites, such as clinoptilolite, chabazite, phillipsite and mordenite occur naturally as minerals, and may be extensively mined in many parts of the world. Although occurring naturally, numerous zeolites may also be used in their synthetic forms such as Zeolite A, X or Y.

Other minerals, aside from those described above, may also appear in the additive. Such minerals include, but are not limited to amorphous opal CT, feldspars, kaolinite, mica and quartz.

To prepare the foregoing materials to be used as additives, they may undergo relatively simple processing. According to one illustrative embodiment, these materials are mined and sized to pre-determined particle sizes. Thereafter, the crushed particles may then be superheated at temperatures ranging up to and including about 1200° C. (2192° F.), and typically at temperatures ranging between 300° C. (572° F.) and 900° C. (1652° F.). The actual heating temperature depends upon the particular raw material used, and can be determined by one skilled in the art. If the superheating temperature and degree of thermal saturation for the particular precursor is too low, the superheated granules may rehydrate upon the addition of water. Under these circumstances, the particles may undesirably flake or disaggregate into their fundamental minerals. Care should also be taken to avoid subjecting the particles to extremely high temperatures. If the temperature is too high, vitrification and densification may occur and porosity/interconnectivity will be lost. Thus, the term superheat, as used herein, means heated to high temperatures (e.g., between 300° C. (572° F.) and 900° C. (1652° F.)) without fusing or vitrifying.

Applicants have found that it is helpful to superheat the phyllosilicates, but that it is an unnecessary process step to superheat diatomaceous earth and zeolites. Both diatomaceous earth and zeolites may, however, undergo superheating without departing from the spirit of the present invention.

Individual particles of the additive, according to an illustrative embodiment of the present invention, may include a substantially dust free granulate with particle sizes ranging between about 0.25 millimeters and about 3.0 millimeters in diameter and more particularly between about 0.5 millimeters and about 1.5 millimeters. These values should be interpreted as producing a mesh size, based on the U.S. standard for measurement, between about 60 mesh and 3.5 mesh. In addition, individual particle size and shape distribution may vary widely. Particles may show a morphology ranging from angular to spheroidal, including, but not limited to lenticular (disk-shaped) or ascicular (rod-shaped).

The additive of the present invention may also exhibit a certain level of porosity. According to one embodiment, individual pore size may be between about 0.0001 microns to about 10.0 microns in diameter and more particularly between about 1.0 microns and about 3.0 microns. Pore size may display a heterogeneous distribution, ranging in size from micro-pores (about 0.0001 microns to 0.002 microns) to meso-pores (about 0.002 microns to 0.05 microns) up to macro-pores (about 0.05 microns to 10 microns). Total porosity and pore size distribution may be measured by standard porosimetry methods, or total porosity may be measured by liquid intake of the additive.

According to another embodiment, total porosity of the additive may be about 10 percent or more, typically between about 20 percent and about 50 percent. Total pore volume, which is the total amount of pore volume per gram of additive material may be between about 0.1 cubic centimeters per gram and about 1.0 cubic centimeters per gram.

In still other embodiments, 5 percent or more of the total porosity may include an interconnected internal porosity, typically between about 15 percent and about 45 percent. The term interconnected internal porosity refers to at least some degree of interconnectivity or a network of paths between the pores within individual particles (intra-particular porosity) and/or between particles lying close together (inter-particular porosity).

Given the above-described porosity, the individual particles comprising the additive may comprise both an internal and external surface area. Thus, the total surface area of the individual particles in these embodiments may be between about 10 meters squared per gram and 1000 meters squared per gram. Internal surface area may be measured by known methodologies, such as surface area measurement by Ethylene Glycol Monoethyl Ether (EGME) or surface area measurement by BET nitrogen gas techniques.

These and other characteristics of the additive of the present invention are beneficial to various aspects of the footing, including cushioning, dust control and watering frequency. A riding surface should be sufficiently cushioned to minimize the concussion on horse legs, yet firm enough to provide traction under wetted conditions. Further, a riding surface should exhibit relatively low levels of dust, to avoid impairing the ability of riders and others to see.

Impact value is a measure of the rate of deceleration of a weighted object on impact with the earth—the lower the number, the more cushioned the impact. To test the impact value, a Clegg Hammer test is employed. During the test, a 2.25 kg Clegg Hammer is dropped from eighteen inches in four locations throughout the arena, with four consecutive test blows per test spot reported. The values are averaged and an impact value, measured in cmax, is calculated. Through use of the additive of the present invention, the footing exhibits an impact value of no more than about 15.0 cmax, and more particularly between about 7.0 cmax and 12.0 cmax.

Dust is measured according to a dry dust index, which is a measure of the total potential dust a material could have. The procedure for measuring the dry dust index includes taking four samples of 3000 g from various locations in the footing and drying each sample to a moisture content of 0. A dry dust index for each of the samples is thereafter measured with a dustometer box according to the method developed and reported by Goss, G. R. and Reisch, F. J., “A Technique for Dust Measrument,” Pesticide Formulation and Application Systems, 8^{th} Vol., ASTM STP890. Since the dry dust index depends, at least in part, on the footing materials employed with the additive, (e.g., sand vs. ground stone), this feature of the invention is expressed in terms of the percentage reduction attributable to the presence of the additive. Thus, a footing employing the additive of the present invention exhibit a reduction in the dry dust index of about 10% to about 50% and more particularly between about 20% and 40% relative to footings comprising the same materials in the absence of the additive.

Periodic watering of the footing is important to maintaining adequate cushioning and controlling dust. In both indoor and outdoor arenas, facility managers typically monitor moisture and periodically water the footing. A water deficiency may lead to cushioning and dust control problems, while excess water forms unwanted puddles and mud.

Daily arena maintenance or grooming, including dragging or harrowing, is necessary to maintain the proper distribution of the footing throughout the arena. Heavy rider traffic often requires more frequent grooming. The combination of more frequent maintenance of the footing material and heavy traffic can increase the rate at which the footing loses moisture, leading to dust control problems.

Absorption capacity is a measure of a footing's fully saturated absorptive capacity for water. Absorptive capacity, according to the present invention, is determined by passing a known amount of water through a known weight of footing material contained in an inclined tube until the sample is completely saturated. Absorption capacity is calculated as the volume of water absorbed per weight of sample, (i.e., the difference by between the volume of water initially added (V₁) and the volume of water recovered (V₂) divided by the sample weight (W) of the footing material tested (Absorption Capacity=(V₁−V₂)/W)). For further details regarding this test, please see General Services Administration, Federal Specification P-A-1056B (1979)—Absorbent Material, Oil and Water (For Floors and Decks).

Footings that incorporate the additive of the present invention advantageously exhibit an increase in absorption capacity between about 5% and to about 50% and more particularly between about 25% and 40% relative to footings comprising the same materials that do not incorporate the additive. Since the additive possesses an interconnected internal porosity, liquid is not limited to traveling along the outer surface of the additive, but may also weave its way throughout the interconnected network of pores and/or temporarily remain within the pores themselves. Thus, water-holding capacity may be increased and more uniformly distributed throughout the footing.

The footing of the present invention may comprise various combinations of materials. In one embodiment, the footing of the present invention comprises sand and the additive. In other embodiment, the footing comprises ground stone and the additive. In yet another embodiment, the footing comprises sand, trace organics, such as stall waste or sawdust, and the additive. In these embodiments, the additive is present in an amount between about 0.5 lbs/ft² and about 7.5 lbs/ft² and more particularly between about 1.0 lbs/ft² and about 4.0 lbs/ft². Alternatively, the footing may be comprised solely of the additive.

The additive may be incorporated into the footing of the horse arena through various techniques. After a footing comprising sand or ground stone is in place, the additive may be incorporated in dry form into the top three inches of the footing, followed by sufficient watering to change the color of the granules from tan to rust brown. In another embodiment, the footing may be partially or fully hydrated prior to incorporation of the additive, followed by a light watering after the additive is incorporated into the top three or four inches of footing. The additive may also be incorporated in two stages, with half in dry form and half in hydrated form, followed by sufficient watering to affect the above-described color change of the granules.

The additive is applied to the footing in a relatively uniform manner, typically through a seeder or by hand. The additive is then typically worked into the footing using a chisel, rototiller, harrow or other instruments known to those of skill in the art.

Variations, modifications and other implementations of what is described herein will occur to those of ordinary skill in the art without departing from the spirit and scope of the invention. Accordingly, the invention is in no way limited by the preceding illustrative description.

What is claimed is:

1. A method comprising:
providing a horse arena including a footing, the footing comprising sand and an organic material;
providing an additive comprising a plurality of particles, wherein at least one particle in the plurality of particles exhibits a surface area between about 10 meters squared per gram and 1000 meters squared per gram; and
applying the additive to the footing in an amount between about 0.5 lbs/ft² and about 7.5 lbs/ft².

2. The method of claim 1, wherein the organic material comprises animal waste or sawdust.

3. The method of claim 1, wherein the additive is selected from the group comprising a phyllosilicate clay mineral, diatomaceous earth and a zeolite.

4. The method of claim 1, wherein at least one of the particles includes a particle size between about 0.25 millimeters and about 3.0 millimeters in diameter.

5. The method of claim 1, wherein at least some of the plurality of particles vary in size.

6. The method of claim 1, wherein an individual particle in the plurality of particles includes at least one pore.

7. The method of claim 6, wherein the at least one pore has a pore size between about 1.0 microns and 3.0 microns.

8. The method of claim 1, wherein the footing, prior to the step of applying the additive, includes a dry dust index and the presence of the additive, after the applying step, reduces the dry dust index by about 10% to about 50%.

9. The method of claim 1, wherein the footing, prior to the applying step, exhibits an absorption capacity and the presence of the additive, after the applying step, increases the absorption capacity by about 5.0% and 50.0%.

10. A method comprising:
providing a horse arena including a footing;
providing an additive comprising a plurality of pores, wherein at least one of the plurality of pores has a pore size of about 0.0001 to about 10 microns in diameter and at least some of the plurality of pores interconnect; and
applying the additive to the footing.

11. The method of claim 10, wherein the additive is selected from the group comprising a phyllosilicate clay mineral, diatomaceous earth and a zeolite.

12. The method of claim 10, wherein at least one of the plurality of particles includes an individual particle size between about 0.25 millimeters and about 3.0 millimeters in diameter.

13. The method of claim 10, wherein the additive comprises a plurality of particles, at least some of which vary in size.

14. The method of claim 10, wherein an individual particle in the plurality of particles has a surface area between about 10 meters squared per gram and 1000 meters squared per gram.

15. The method of claim 1, wherein at least one of the plurality of pores has a pore size of about 1.0 microns and 3.0 microns in diameter.

16. The method of claim 10, wherein the footing, prior to the step of applying the additive, includes a dry dust index and the presence of the additive, after the applying step, reduces the dry dust index by about 10% to about 50%.

17. The footing of claim 10, wherein the plurality of particles has a total pore volume of up to about 1 cubic centimeter per gram.

18. A method comprising:
providing a horse arena including a footing;
providing an additive comprising a plurality of superheated particles comprising a plurality of pores, wherein at least one of the plurality of pores does not collapse after superheating and wherein at least some of the plurality of pores are interconnected.
applying the additive to the footing.

19. The method of claim 18, wherein the additive is selected from the group comprising a phyllosilicate clay mineral, diatomaceous earth and a zeolite.

20. The method of claim 18, wherein at least one of the plurality of pores has a pore size of about 0.0001 to about 10 microns in diameter.

21. The method of claim 18, wherein at least some of the superheated particles vary in size.

20. A method comprising the steps of:
providing a horse arena including a footing;
providing an additive selected from the group consisting of a phyllosilicate clay mineral, diatomaceous earth and a zeolite, wherein the additive comprises a plurality of pores and at least some of the plurality of pores interconnect; and
applying the additive to the footing, wherein the footing, prior to the step of applying the additive, includes a dry dust index and the presence of the additive, after the applying step, reduces the dry dust index by about 10% to about 50%.

21. A method comprising the steps of:
providing a horse arena including a footing, the footing comprising a material selected from the group consisting of a phyllosilicate clay mineral, diatomaceous earth and a zeolite, wherein the material is present in the footing in an amount between about 1 pound per square foot to 6 pounds per square foot and wherein the footing includes an impact value between about 7.0 cmax and 15.0 cmax.
